(19) United States
(12) Patent Application Publication
(10) Pub. No.: US 2017/0274331 A1
(43) Pub. Date: Sep. 28, 2017

(54) Horizontal Fluent Material Dispenser

(71) Applicant: KSI Conveyor, Inc., Sabetha, KS (US)

(72) Inventors: Matthew J. Edelman, Sabetha, KS (US); Duane A. Kaeb, Sabetha, KS (US); Paul A. Kaeb, Sabetha, KS (US)

(73) Assignee: KSi Conveyor, Inc., Sabetha, KS (US)

(21) Appl. No.: 15/464,770

(22) Filed: Mar. 21, 2017

Related U.S. Application Data
(60) Provisional application No. 62/312,237, filed on Mar. 23, 2016.

(51) Int. Cl. B01F 3/18; G01F 13/00; B65G 33/14; A01C 1/06; B01F 7/04; B01F 7/00; B01F 15/02; B65D 83/06; B65G 33/32

(52) U.S. Cl. CPC B01F 3/184; B65D 83/06; G01F 13/005; B65G 33/14; B65G 33/32; B01F 7/042; B01F 7/046; B01F 7/00266; B01F 7/00725; B01F 15/0289; A01C 1/06; B01F 2215/0009

(57) ABSTRACT

A horizontal fluent material dispenser for the even dispensing of a metered quantity of powder. A hopper holds the powder. The hopper has a mixing portion with rotating beaters. A horizontal conduit is coupled to the hopper and receives powder from the hopper. A screw conveyor—or auger—within the conduit transfers the material through the horizontal conduit. A knife assembly, disposed at the distal longitudinal end of the screw conveyor, breaks off a continuous and even flow of powdered material out the discharge opening. A modular screw conveyor assembly is disclosed for changing the material dispensing rate range without changing the conduit diameter. A dual drive mechanism is also disclosed for independent adjustment of the rotating beater speed and the screw conveyor.

### CROSS REFERENCES

This application claims the benefit of U.S. Provisional Application No. 62/312,237, filed Mar. 23, 2016.

### FIELD OF INVENTION

We disclose an apparatus for measuring by volume and delivering fluent solid materials comprising a screw conveyor and a knife assembly. Specifically, we disclose a horizontally oriented apparatus for the even dispensing of a metered quantity of powder.

### BACKGROUND

Existing fluent material dispensers are subject to the material clogging and clumping at the discharge end. Attempts to resolve this problem have been attempted previously, as disclosed, for example, by Hirsch U.S. Pat. No. 7,487,892 and U.S. Pat. No. 8,556,129. However, the addition of a dispersal screen creates an additional location for clogging and clumping of fluent material.

### BRIEF DESCRIPTION

We disclose an apparatus for the even dispensing of a metered quantity of powder. A hopper holds the powder. The hopper has a mixing portion having a first beater and a second beater. A conduit is coupled to the hopper and receives powder from the hopper. The conduit extends horizontally from the hopper. A screw conveyor—or auger—within the conduit transfers the material through the horizontal conduit. The horizontal conduit has a distal end, away from the hopper, that has a discharge end for dispensing the material. As the screw conveyor turns, the material is transferred through the conduit and toward the discharge end. A knife assembly, disposed at the distal longitudinal end of the screw conveyor, breaks off a continuous and even flow of powdered material out the discharge opening.

In order to provide an even flow of material to the knife assembly, the apparatus may have a spacing element disposed within the conduit between the distal longitudinal end of the screw conveyor and the knife assembly. The spacing element may facilitate the even compaction of the fluent material to be dispensed.

The knife assembly may have multiple vanes radially extending from a central collar. Each vane can have one or more beveled edges to facilitate shaving the compacted material into a constant stream. Each vane has a leading edge and a trailing edge. In one embodiment, the leading edge is beveled. However, it is also possible that the knife assembly employs vanes comprising round bars, for example the knife assembly can comprise multiple round bars radially extending from a central collar like the hands of a clock. It is also possible that the knife assembly is knife has a single vane.

The knife assembly and screw conveyor must be powered. In one embodiment, a motor is operationally coupled to turn both the screw conveyor and the knife assembly. The spacing element can either be rotated or stationary. For example, the motor is operationally coupled to a rotating, keyed shaft. The screw conveyor has a complementary longitudinal slot for receiving the keyed shaft and rotating with the keyed shaft. Similarly, the knife assembly has a slot for receiving and rotating with the keyed shaft. The spacing element may have a keyed slot for receiving and rotating with the keyed shaft.

Another advantage of this technology is that the dispensing rate range of the horizontal fluent material dispenser can be adjusted by varying the root diameter of the screw conveyor. The screw conveyor can consist of a narrow root shaft with elongated spiral blades. Alternatively, the screw conveyor can consist of a wide root shaft with narrow spiral blades. The wide shaft embodiment may provide the advantage of decreasing the flow rate of material compared with a narrow shaft screw conveyor through conduits of similar diameter. In order to achieve similar flow rates with the wider shaft, the motor needs to turn the screw auger at a higher number of rotations per minute. By powering the knife assembly on the same rotating shaft as the auger, the number of rotations per minute of the knife assembly also increased.

Another advantage of this technology is that multiple modular screw conveyor portions can be utilized to control the material flow. For example, a first screw conveyor flight module can be installed under the hopper portion to load the conduit with powdered material. A second screw conveyor flight module can be coupled to the first screw conveyor flight module. This second screw conveyor flight module can have the same root-blade profile as the first screw conveyor flight module or can have a different root-blade profile. The selection of the proper root-blade profile will depend on the material to be dispensed and the specific application. For example, in seed treatment implementations, the amount of dry agrochemical material dispensed may vary depending on the type of agrochemical and the seed treatment rate.

The root-blade profile can be altered to provide flow volume and flow rate. For example, the screw conveyor can comprise a plurality of spiral blades which provides a more rapid rate of horizontal travel per rotation than a single spiral blade.

Another advantage is that the conduit provides a hood of the discharge aperture, to prevent material from flowing into the conduit. In seed treatment implementations, the fluent material dispenser may dispense dry agrochemical additives such as talc or graphite. The treated seed is wet and sticky. The hood prevents the wet, sticky seed from entering the conduit and blocking the flow of the powdered agrochemicals.

A control system can be coupled with the motor to adjust the dispensing rate. The control system regulates the speed of the screw conveyor. For example, a motor may be directly connected to a first beater, with a sprocket gear for receiving a chain for driving both a second beater and the screw conveyor. By regulating the speed of the motor, the speed of the beaters and the speed of the screw conveyor are affected. In another embodiment, a separate motor is coupled to the screw conveyor to independently control the speed of the screw conveyor relative to the speed of the first beater and the second beater.

### BRIEF DESCRIPTION OF DRAWINGS

Aspects are illustrated by way of example, and not by way of limitation, in the accompanying drawings, wherein:

FIG. 1 comprises a view of the distal end of the screw conveyor with the knife assembly;

FIG. 2 comprises a front top perspective view of the horizontal fluent material dispenser with the conduit shown transparent to reveal the screw conveyor;

FIG. 3 comprises a rear top perspective view of the horizontal fluent material dispenser showing the motor and drive cover;

FIG. 4 comprises a front perspective view of the horizontal fluent material dispenser;

FIG. 5 comprises a side perspective view of the screw conveyor showing the hex shaft portions;

FIG. 6 comprises a side perspective enlarged view of a portion of the conduit and a screw conveyor portion having a deep root-blade portion;

FIG. 7 comprises a side perspective view of a screw conveyor portion having a shallow blade amplitude relative to the screw conveyor portion of FIG. 6;

FIG. 8 comprises a side perspective view of a portion of a screw conveyor portion having an increased blade frequency relative to the screw conveyor portion of FIG. 6;

FIG. 9 comprises a top perspective view of a unitary screw conveyor, spacing element, and a knife assembly having vanes with beveled edges;

FIG. 10 comprises a front perspective view of a dispensing portion having a knife assembly with round bar vanes;

FIG. 11 comprises a front perspective view of a dispensing portion having a knife assembly with non-beveled vanes;

FIG. 12 comprises a front perspective view of a dispensing portion having a knife assembly with non-beveled vanes;

FIG. 13 comprises a front top perspective view of the mixing portion of the hopper;

FIG. 14 comprises a top perspective view of the mixing portion of the hopper;

FIG. 15 comprises a rear perspective view of the drive belt connections of the horizontal fluent material dispenser;

FIG. 16 comprises a top front perspective view of a dispensing portion having a knife assembly with non-beveled vanes;

FIG. 17 comprises a front perspective view of a dispensing portion having a knife assembly with non-beveled vanes;

FIG. 18 comprises a side perspective view of a dispensing portion having a knife assembly with non-beveled vanes;

FIG. 19 comprises a flow chart of the process for changing the dispensing rate range of the dispenser without changing the conduit diameter;

FIG. 20 comprises a flow chart of the process for regulating the screw conveyor speed.

FIG. 21 comprises a flow chart of the process for adjusting the flow rate of a fluent material dispenser having a horizontal conduit.

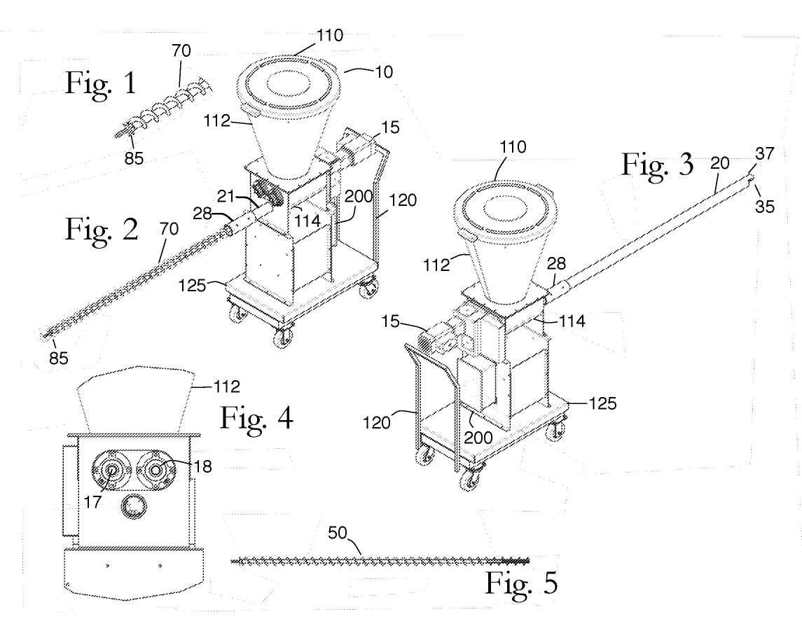

### DESCRIPTION

As noted above, this horizontal fluent material dispenser overcomes numerous problems, such as:
a. Providing a continuous, even flow of powdered agrochemicals;
b. Varying the dry material discharge rate ranges without changing the conduit diameter;
c. Preventing wet, sticky seed from entering the discharge aperture of the conduit; and
d. Separating the drive control for the screw conveyor from the mixing beaters.

We disclose an apparatus for the even dispensing of a metered quantity of powder over a large range of dispensing rates. A hopper 10 holds the powder. The hopper 10 has an upper portion 112, a lower portion 114, and a mixing portion 11. The mixing portion 11 has a first beater 17 and a second beater 18. A conduit 20 is coupled to the hopper 10 and receives powder from the hopper 10 by flow of gravity. The conduit 20 extends horizontally from the lower portion 114 of the hopper 10.

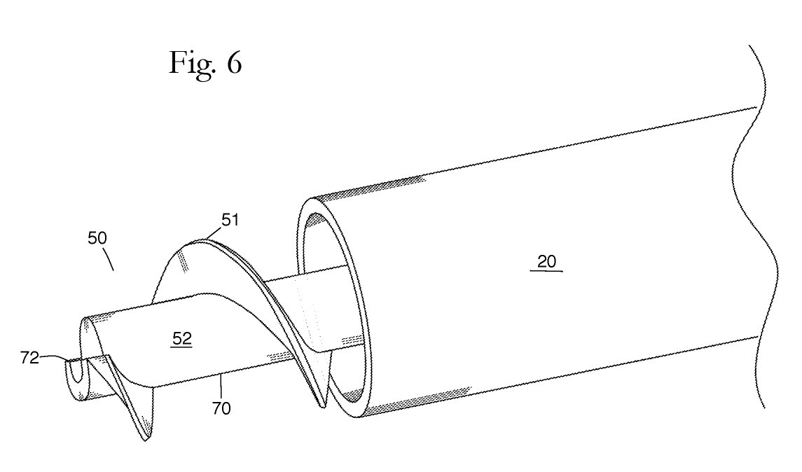

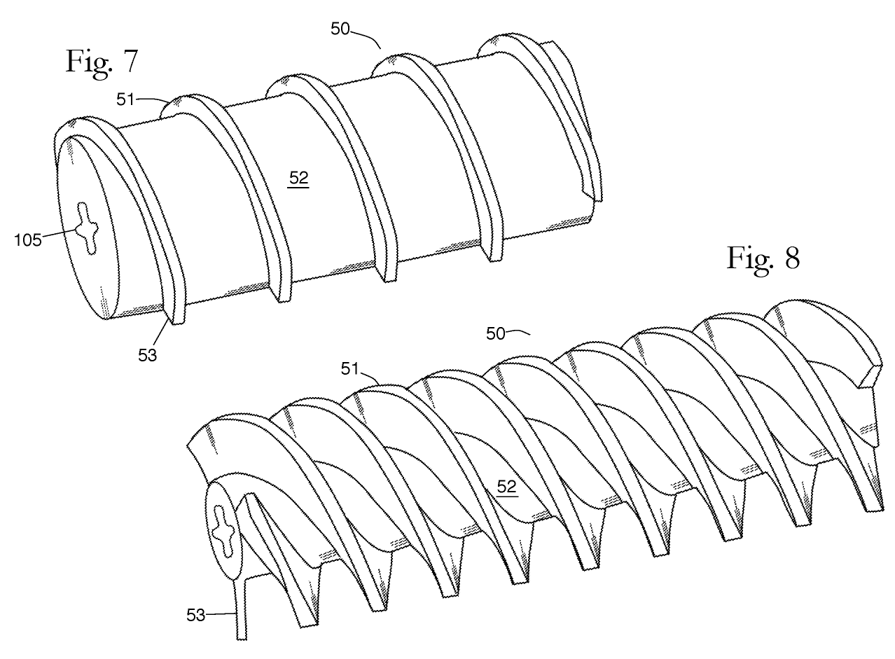

A screw conveyor 50 within the conduit 20 transfers the material horizontally through the conduit. Several embodiments of the screw conveyor 50 having different root-blade profiles are illustrated in FIGS. 6 through 9. A portion of the screw conveyor 50 is disposed within the horizontal conduit and a portion of the screw conveyor disposed within the lower portion of the hopper. As shown in FIG. 5, the screw conveyor 50 can be a singular, unitary assembly. Alternatively, as illustrated in FIG. 6, the screw conveyor 50 can be made of multiple, modular portions that are rotationally coupled to each other by a coupling portion 72. This coupling portion 72 can comprising a keyed shaft—such as a hex shaft—and complementary keyed slot. Alternatively, the coupling portion 72 can comprise a half-circle portion with a central arcuate slot—as illustrated in FIG. 6—and the subsequent portion comprises a complementary half-circle portion with a complementary tab that is accepted within the central arcuate slot. In this way, the subsequent portions are rotationally coupled to the upstream portions.

Once transferred horizontally through the length of the conduit 20, the material is discharged through a discharge aperture 35. The discharge aperture 35 is disposed at a distal end 25 of the conduit 20, away from the hopper 10. As the screw conveyor 50 turns, the material is transferred through the conduit 20 and toward the discharge point at the distal end 25.

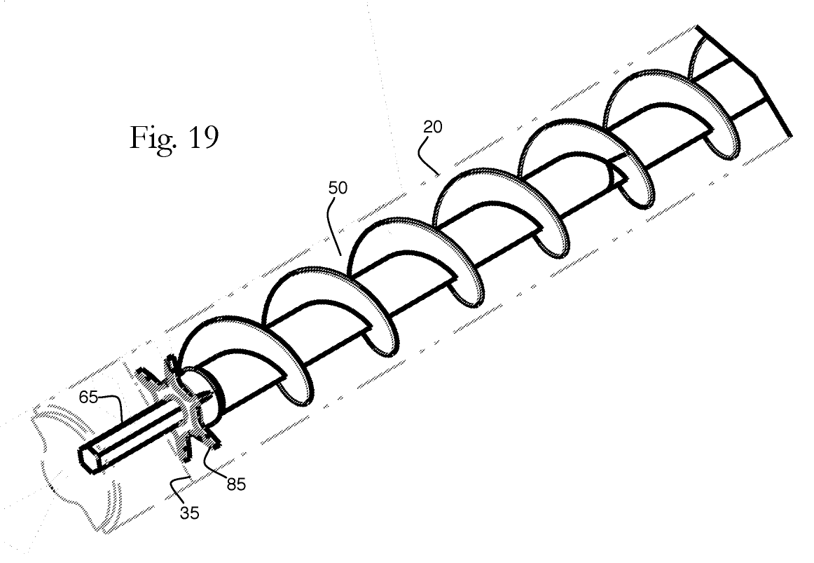

The material is continuously broken off into a fine, even flow with a knife assembly 85. The knife assembly 85 is disposed at the distal longitudinal end of the screw conveyor, breaks off a continuous and even flow of powdered material out the discharge opening. The knife assembly 85 is disposed adjacent to and above the discharge aperture 35, as shown in FIG. 19. In this orientation, the fluent material has a direct free fall path from the cutting point of the knife assembly 85 through the discharge aperture, so no material clumps or piles up. There is no portion of the conduit 20 to allow the material to clump, aggregate, or accumulate. Similarly, the lateral length of the vanes 90 is sufficient short and knife-like so that the material does not clump, aggregate, or accumulate. Rather, a continuous stream of powdered material is dispensed through the discharge aperture 35.

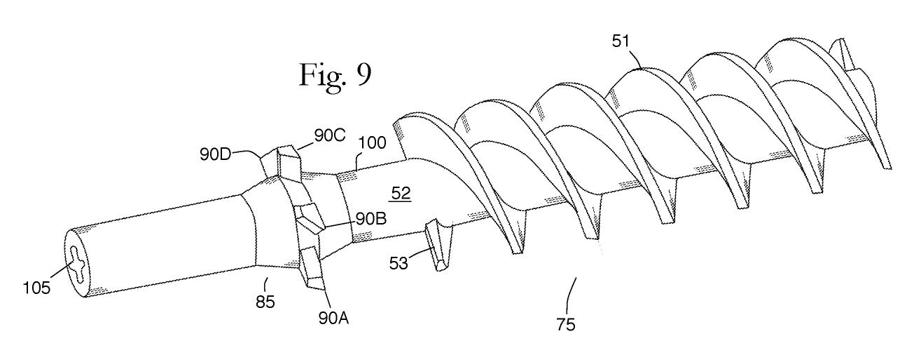

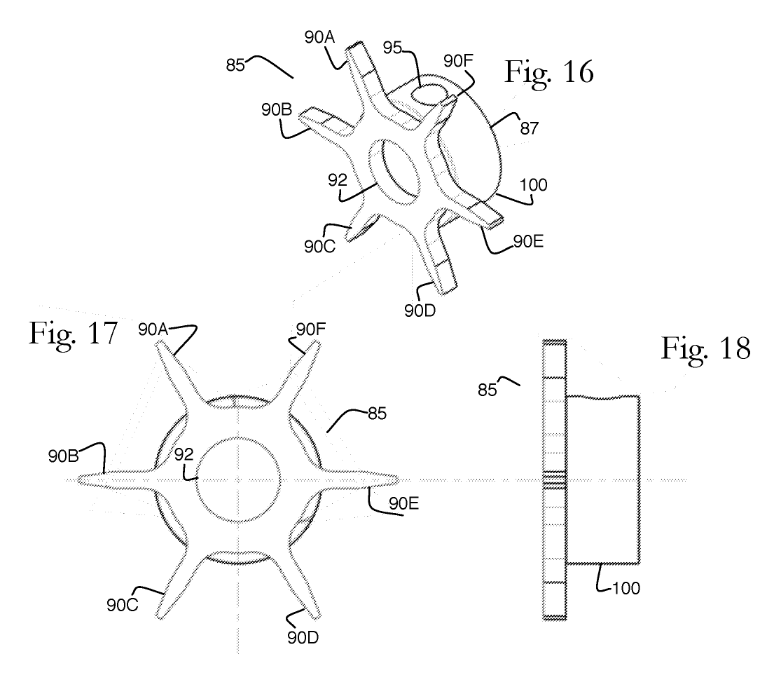

The knife assembly 85 may have multiple vanes radially extending from a central ring shaft. Each vane can have one or more beveled edges to facilitate shaving the compacted material into a constant stream. Each vane has a leading edge and a trailing edge. As illustrated in FIGS. 9, 16, and 17, the vanes have an edge that is beveled. However, it is also possible that the knife assembly 85 employs vanes comprising round bars, for example the knife assembly 85 can comprise multiple round bars radially extending from a central ring shaft 87 like the hands of a clock. It is also possible that the knife assembly 85 is knife has a single vane. It is important that the vanes do not have a deep lateral edge, so that the vanes cut through the compacted fluent material and cause the material to fall through the discharge aperture 35.

In embodiments having a powered shaft or a keyed shaft extending from the upstream screw conveyor portion, the knife assembly 85 may be secured to the shaft by a fastener (not shown) received through a fastener receiver 95 in the ring shaft 87. The fastener extends through the fastener receiver 95 to engage the shaft. The knife assembly 85 may also receive the rotational power through a keyed slot 105, as shown in FIG. 11. The keyed slot 105 is complementary to a keyed portion of the shaft 65. In this embodiment, a fastener receiver 95 may function to secure the lateral position of the knife assembly 85.

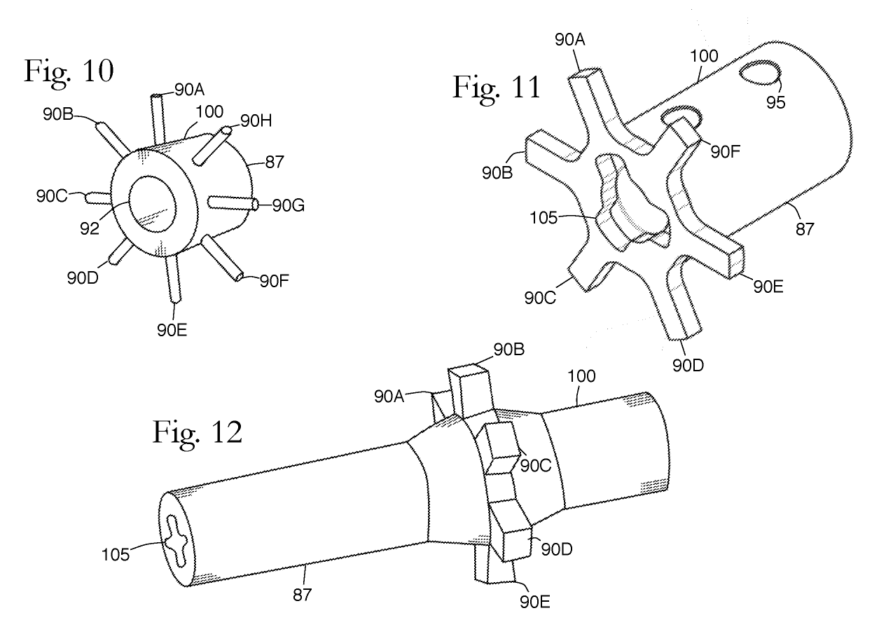

In order to provide an even flow of material to the knife assembly 85, the apparatus may have a spacing element 100 disposed within the conduit 20 between the distal longitudinal end of the screw conveyor and the knife assembly 85. The spacing element 100 is shown most clearly in FIGS. 9, 10, 11, 12, 16, and 18. The spacing element 100 may facilitate the even compaction of the fluent material to be dispensed between the pushing blades of the screw conveyor 50 and the vanes 90 of the knife assembly. The spacing element 100 is disposed within the conduit at the distal end of the screw conveyor 50.

The knife assembly 85 may be a unitary assembly with a screw conveyor portion, as shown in FIG. 9. Alternatively, the knife assembly 85 can be a unitary assembly with the spacing element 100, as shown in FIGS. 11 and 12. Alternatively, the knife assembly 85 can be a separately installed component. The knife assembly portion is rotationally coupled to at least one of the screw conveyor portion 70, the shaft 65, or the spacing element 100.

To deliver the fluent material, such as a powdered agrochemical, a horizontal conduit extends from the lower portion of the hopper. The conduit can also be referred to as a stinger in the context of a seed treatment system application, as the conduit is inserted into the mixing-drying drum through either the inlet opening or the discharge opening. The mixing-drying drum is not disclosed in detail in this application, but would be similar to the mixing-drying drum disclosed in U.S. patent application Ser. No. 14/301,404 by Terry N. Kaeb et al., the disclosure of the mixing-drying drums and the inlet opening and discharge opening is incorporated herein by reference.

In order to protect the wet, sticky, freshly treated seed from entering into the conduit 10, the conduit has a hood portion 37 that extends over the discharge aperture. As illustrated in FIG. 3, the hood portion 37 extends horizontally past the

The knife assembly 85 and screw conveyor 50 must be powered to transfer the material through the conduit 20 and to allow the knife assembly 85 to break off the material. In one embodiment, a mixing motor 15 is operationally coupled to turn the first beater 17 and the screw conveyor 50. The rotating knife is rotationally coupled to the screw conveyor 50, and receives the rotational power through the screw conveyor. The spacing element can either be rotated or stationary. For example, the motor is operationally coupled to a rotating, keyed shaft. The screw conveyor has a complementary longitudinal slot for receiving the keyed shaft and rotating with the keyed shaft. Similarly, the knife assembly 85 has a slot for receiving and rotating with the keyed shaft 65. The spacing element may have a keyed slot for receiving and rotating with the keyed shaft 65.

Another advantage of this technology is that the dispensing rate range of the horizontal fluent material dispenser can be adjusted by varying the root diameter of the screw conveyor. The screw conveyor can consist of a narrow root shaft with elongated spiral blades. Alternatively, the screw conveyor can consist of a wide root shaft with narrow spiral blades. The wide shaft embodiment may provide the advantage of decreasing the flow rate of material compared with a narrow shaft screw conveyor through conduits of similar diameter. In order to achieve similar flow rates with the wider shaft, the motor needs to turn the screw auger at a higher number of rotations per minute. By powering the knife assembly 85 on the same rotating shaft as the auger, the number of rotations per minute of the knife assembly 85 also increased.

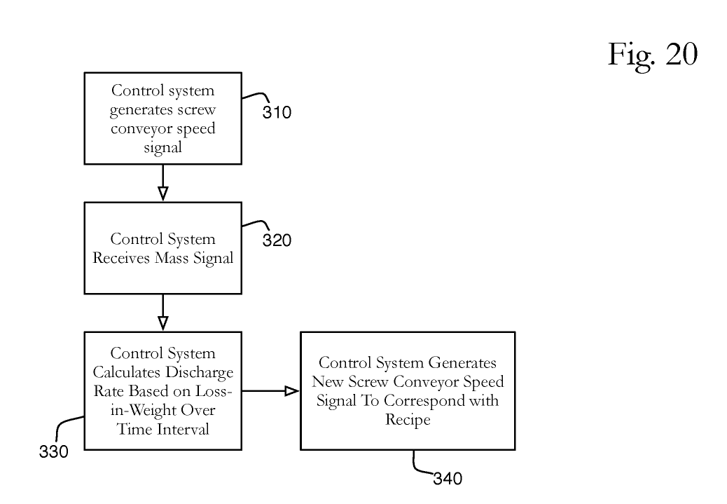

In order to properly dispense the material at a predetermined rate, a scale 125 may be provided that receives the hopper 10 and the hopper 10′s contents to generate a mass signal. As shown in FIG. 20, a control system 200 is configured to generate a screw conveyor speed signal to control a rotational speed of the screw conveyor, as shown in Step 310. The control system is further configured to receive the mass signal from the scale 125, as shown in step 320. The control system then calculates a measured flow rate of the material based on a change in the mass signal over time, as shown in step 330. The control system is further configured to change the screw conveyor speed signal in accordance with a recipe in order to achieve the desired discharge rate, as shown in step 340.

The horizontal fluent material dispenser can be used with a seed treatment application system. The conduit 20 is configured to extend into a mixing-drying drum. In this application, the control system 125 is configured to receive a seed flow rate signal from the seed treatment system. A scale-based seed applicator can generate a mass-based loss-in-weight seed flow rate signal. Alternatively, a seed wheel can generate a volumetric seed flow rate signal. These methods of generating a seed flow rate signal are known in the art. The control system 125 is further configured to change the screw conveyor speed signal in accordance with a recipe based on the seed flow rate in order to dispense a quantity of dry, powdered agrochemical corresponding to the quantity of seed in the mixing-drying drum.

Certain applications of the horizontal fluent material dispenser may require a low dispensing rate and other application require a much higher dispensing rate. It is possible to adjust the range of dispensing rates through a standard diameter conduit by adjusting the blade-root profile of the screw conveyor 50 or a portion of the screw conveyor. A first screw conveyor blade portion 70 is provided having a first total diameter equal to an inner surface diameter of the conduit. The first screw conveyor blade portion 70 has a first blade-root profile for operating at a first discharge range. A second screw conveyor blade portion (not shown) is also provided having a first total diameter equal to an inner surface diameter of the conduit. The second screw conveyor blade portion has a second blade-root profile for operating at a first discharge range. For example, the first screw conveyor blade portion may have the blade-root profile shown in FIG. 6 and the second screw conveyor blade portion may have the blade-root profile as shown in FIG. 7 or FIG. 8. As shown in the illustration, the blade portion of the screw conveyor portion shown in FIG. 7 has a larger diameter root 52 and a smaller blade height 53 compared with FIG. 6. As shown in the illustration, the blade portion of the screw conveyor portion shown in FIG. 8 has a smaller diameter root 52 and a larger blade height 53 compared with FIG. 6. It may be helpful to discuss the blade-root profile in terms of blade-amplitude and blade-frequency. As the blade-amplitude increases from FIG. 7 to FIG. 8, the root diameter decreases and then dispensing rate range increasing. The blade-root profile of the screw conveyor portion in FIG. 8 has a higher blade-frequency. As the blade-frequency increases, the horizontal speed that the material is conveyed through the conduit 20 is increased.

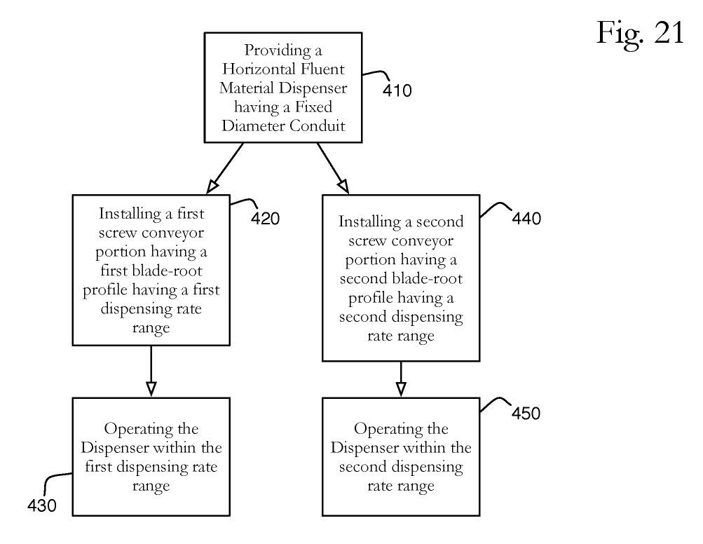

As shown in FIG. 21, by switching a screw conveyor portion with a first blade-root profile with a screw conveyor portion having a second blade-root profile, the user can change the dispensing rate range without changing the conduit size. The horizontal fluent material dispenser utilizes a fixed diameter conduit, as shown in step 410. For larger dispensing rate operations, the user installs a screw conveyor portion having a taller blade height into the conduit, as shown in step 420. The user can then operate the horizontal fluent material dispenser at a higher discharge rate range, as shown in step 430. For smaller dispensing rate operations, the user installs a screw conveyor portion having a shorter blade height into the conduit, as shown in step 440. The user can then operate the horizontal fluent material dispenser at a lower discharge rate range, as shown in step 450. By maintaining the total diameter of the screw conveyor 50 equal with the inner surface of the conduit 20, the rate change does not require a different machine specification.

As such, the screw conveyor portions are modular and interchangeable. As shown in FIG. 3, the conduit is coupled with a coupler 28 to a hopper screw conveyor portion 21. By removing the conduit 20 from the coupler 28, the blade portions can be interchanged. In this way, the dispensing range rate of the horizontal fluent material dispenser can be changed without changing the diameter of the conduit 20.

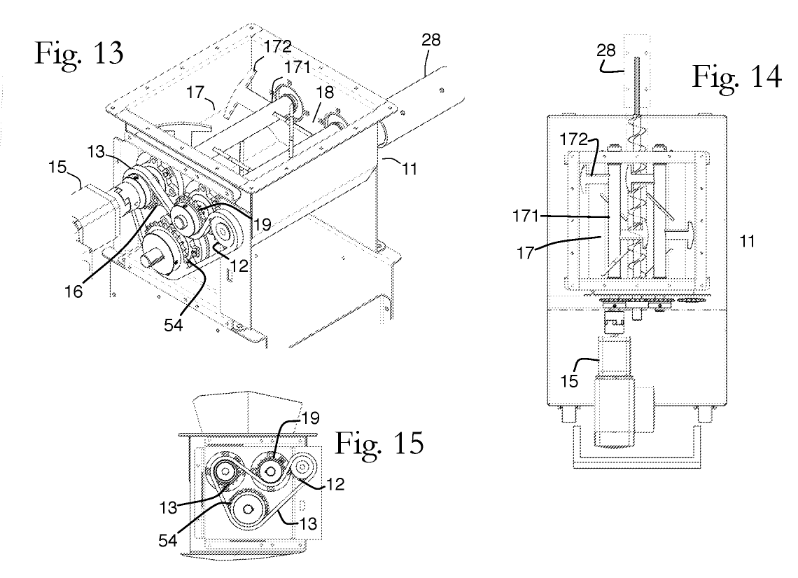

In order to power the mixing portion 11 and the screw conveyor 50, a power distribution area is shown in FIGS. 13 and 15. A belt 13 is connected about a variety of sprockets, the belt could be smooth, segmented, or chain. The mixing motor 15 is connected the beater axel 171 of the first beater 17. The mixing motor 15 causes the beater axel 171 to turn, and to cause the beater blades 172 to mix the fluent material held within the hopper 10. The axle 171 extends horizontally through the hopper 10. The axle 171 is mechanically coupled to the mixing motor 15. A driving sprocket 16 is attached to the beater axel 171. A belt 13 transfers the rotational power from the driving sprocket 16 to the driven beater sprocket 19, the idler 12, and the screw conveyor sprocket 54. Alternatively, the belt 13 can be mounted to the driving sprocket 16 and the driven beater sprocket 19. A separate conveyor motor (not shown) can be attached directly to the screw conveyor 50. Alternatively, a separate rotational power source (not shown) can otherwise be mechanically coupled to the screw conveyor sprocket independent of the drive mechanism for the mixing beaters. When the screw conveyor is mechanically coupled to the separate rotational power source, the screw conveyor can be operated at a rotational speed independent of mixing beater speed.

Another advantage of this technology is that multiple modular screw conveyor portions can be utilized to control the material flow. For example, a hopper screw conveyor module can be installed under the hopper 10 portion to load the conduit with powdered material. A second screw conveyor flight module can be coupled to the first screw conveyor flight module. This second screw conveyor flight module can have the same root-blade profile as the first screw conveyor flight module or can have a different root-blade profile. The selection of the proper root-blade profile will depend on the material to be dispensed and the specific application. For example, in seed treatment implementations, the amount of dry agrochemical material dispensed may vary depending on the type of agrochemical and the seed treatment rate.

The root-blade profile can be altered to provide flow volume and flow rate. For example, the screw conveyor can comprise a plurality of spiral blades—an increase in blade-frequency—which provides a more rapid rate of horizontal travel per rotation than a single spiral blade.

In seed treatment implementations, the fluent material dispenser may dispense dry agrochemical additives such as talc or graphite. The hood 37 of the discharge aperture prevents material from flowing into the conduit. The treated seed is wet and sticky. The hood prevents the wet, sticky seed from entering the conduit and blocking the flow of the powdered agrochemicals.

The control system 200 can be coupled with the motor to adjust the dispensing rate. The control system regulates the speed of the screw conveyor. For example, a motor may be directly connected to a first beater, with a sprocket gear for receiving a chain for driving both a second beater and the screw conveyor. By regulating the speed of the motor, the speed of the beaters and the speed of the screw conveyor are affected. In another embodiment, a separate motor is coupled to the screw conveyor to independently control the speed of the screw conveyor relative to the speed of the first beater and the second beater.

For use with a seed treatment applicator, the horizontal conduit can be inserted through the discharge opening or the inlet opening of the mixing drying drum. The fluent material dispenser can be mounted to a hydraulic lift cart

In one embodiment, the length of the spacing element is 1.5 inches. In another embodiment, the length of the spacing element is less than 6 inches. In another embodiment, the length of the spacing element is between 0.5 inches and 3 inches.

We also disclose a method for the even dispensing of a metered quantity of powder, the apparatus comprising:
a. providing a hopper for holding a quantity of powder;
b. providing a conduit coupled to the hopper and configured to receive powder from the hopper, the conduit extending horizontally from the hopper, the conduit comprising:
   i. a distal end;
   ii. a discharge aperture extending along a longitudinal portion of the distal end of the conduit;
c. rotating a screw conveyor disposed within the conduit;
d. a spacing element disposed within the conduit at the distal longitudinal end of the screw conveyor;
e. a knife assembly 85, disposed at the distal longitudinal end.

In one embodiment, the screw conveyor, spacing element, and knife assembly 85 are integrally formed. The screw conveyor, spacing element, and knife assembly 85 can be made of plastic or metal. In another embodiment, a screw conveyor module portion is integrally formed with the spacing element 100 and the knife assembly 85. Integrally forming these portions prevents the material backfill pressure from displacing the knife assembly 85.

The screw conveyor can consist of a narrow root shaft with elongated spiral blades. Alternatively, the screw conveyor can consist of a wide root shaft with narrow spiral blades. The wide shaft embodiment provides the advantage of decreasing the flow rate of material compared with a narrow shaft screw conveyor through conduits of similar diameter. In order to achieve similar flow rates with the wider shaft, the motor needs to turn the screw auger at a higher number of rotations per minute. By powering the knife assembly 85 on the same rotating shaft as the auger, the number of rotations per minute of the knife assembly 85 also increased. In another embodiment, a distal portion of the screw conveyor can comprise a plurality of spiral blades.

In one embodiment, the conduit 20 has an internal diameter of 2.06″. The vanes of the knife assembly 85 have an outer diameter of 1.94″. This allows a 0.06″ radial gap between the distal end of the individual vanes of the knife assembly 85 and the internal surface of the conduit 20. The size of the conduit 20 and length of the vanes 90 of the knife assembly 85 are variable. In another embodiment, the discharge aperture 35 is configured such that its proximal longitudinal edge is slanted. The knife assembly 85 is aligned with the most proximal portion of the discharge aperture 35. In another embodiment, the discharge aperture comprises a 180-degree opening along a longitudinal portion of the conduit. The 180-degree opening is oriented 45 degrees from horizontal. In this configuration, the conduit is closed in 45-degree portion below horizontal on the trailing portion, as determined by the rotation of the vanes of the knife assembly 85. As the knife assembly 85 rotates, the fluent material is pushed toward the open portion of the discharge aperture 35. In another assembly, the 180-degree opening of the discharge aperture 35 is the lower 180-degrees of the conduit 20.

In an embodiment with a 2-inch internal diameter conduit, the throughput of fluent material can range from 0.125 to 120 ounces per minute. The rate depends on the size of the conduit, the root-blade profile of the screw conveyor, and rotational speed of the screw auger.

In one embodiment, the spacing element 100 provides a transition space between the screw conveyor 50 and the knife assembly 85. In this transition space, the spiral blades do not directly contact the fluent material. This transition space may stabilize the flow of the fluent material before the material contacts the knife assembly 85. In one embodiment, the spacing element 100 has the same diameter as the central collar of the knife assembly 85. In another embodiment, the spacing element 100 has the same diameter as the root 52 of the screw conveyor 50.

In one embodiment, the spacing element 100 and knife assembly 85 are integrally connected as a unified flow equalizer, as shown in FIG. 12. The flow equalizer has a complementary keyed slot 105 for being operationally coupled to the motor. The flow equalizer may further comprise a tensioner slot 92 for securely mounting the flow equalizer to the rotating shaft in the proper lateral position. In this embodiment, the flow equalizer slot may not be keyed, but rather the flow equalizer is operationally connected to the rotating shaft or the screw conveyor 50 by means of properly installed fastener in the tensioner slot 92. In another embodiment, the flow equalizer comprises 2 inches to 6 inches of spiral blades; 1 inch to 3 inches of spacing elements; and the knife assembly 85.

In another embodiment, the dispenser is mounted to an adjustable portable support stand. The stand is mounted on wheels, as shown in FIGS. 2-3. The swivel wheels allow the dispenser to be portable and operate in different locations. The support is vertically adjustable. The support incorporates an actuator assisted lift or lower assist. The actuator may be a pneumatic, hydraulic, or electronic linear actuator. This allows the dispenser to be positioned precisely, both vertically and laterally. A foot pedal allows the user to raise the dispenser. A hand lever allows the user to lower the dispenser.

It is understood that other embodiments will become readily apparent to those skilled in the art from the following detailed description, wherein various embodiments are shown and described by way of illustration only. As will be realized, the concepts are capable of other and different embodiments and their several details are capable of modification in various other respects, all without departing from the spirit and scope of what is claimed as the invention. Accordingly, the drawings and detailed description are to be regarded as illustrative in nature and not as restrictive.

We claim:

1. A horizontal fluent material dispenser comprising:
a. A hopper having an open top portion and a lower portion;
b. A horizontal conduit extending from the lower portion of the hopper, the horizontal conduit comprising:
i. A discharge aperture near the distal end;
c. A screw conveyor disposed within the horizontal conduit having a distal end and a portion of the screw conveyor disposed within the lower portion of the hopper;
d. A spacing element disposed within the conduit at the distal end of the screw conveyor;
e. A knife assembly vertically above the discharge opening.

2. The horizontal fluent material dispenser of claim 1, wherein the horizontal conduit further comprises a hood portion that extends over the discharge aperture.

3. The horizontal fluent material dispenser of claim 2, wherein the knife assembly comprises a plurality of vanes extending radially towards an inner surface of the conduit.

4. The horizontal fluent material dispenser of claim 3, wherein each of the vanes has a beveled portion.

5. The horizontal fluent material dispenser of claim 3, wherein the dispenser is mounted on an adjustable portable support stand, the adjustable portable support stand having a plurality of wheels and an actuator-assisted lift.

6. The horizontal fluent material dispenser of claim 1, further comprising:
a. A first rotational power source;
b. A mixing assembly disposed within the hopper, the mixing assembly comprising:
i. An axle that extends horizontally through the hopper, the axle being mechanically coupled to the first rotational power source to rotate the mixing assembly at a first mixing assembly speed;
c. A second rotational power source;
d. Wherein the screw conveyor is mechanically coupled to the second rotational power source to rotate the screw conveyor at a first conveyor speed, such that the first mixing assembly speed is independent of the first conveyor speed.

7. The horizontal fluent material dispenser of claim 1, further comprising:
a. A scale that receives the hopper and generates a mass signal.

8. The horizontal fluent material dispenser of claim 7, further comprising:
a. A control system configured to generate a screw conveyor speed signal to control a rotational speed of the screw conveyor.

9. The horizontal fluent material dispenser of claim 8, wherein the control system is further configured to:
a. receive the mass signal and calculate a measured flow rate of the material based on a change in the mass signal over time; and
b. to change the screw conveyor speed signal in response to the measured flow rate in accordance with a recipe.

10. A seed treatment application system, comprising:
a. The horizontal fluent material dispenser of claim 9;
b. Wherein the conduit is configured to extend into a mixing-drying drum;
c. Wherein the control system is configured to receive a seed flow rate signal; and
d. Wherein the control system is further configured to change the screw conveyor speed signal in accordance with a recipe based on the seed flow rate.

11. A method for increasing the discharge rate range of a horizontal fluent material dispenser comprising:
a. Providing the apparatus of claim 1; and
b. Providing a first screw conveyor portion having:
i. a first total diameter equal to an inner surface diameter of the conduit; and
ii. a first blade-root profile for operating within a first discharge range;
c. Providing a second screw conveyor portion having:
i. a second total diameter equal to the inner surface diameter of the conduit; and
ii. a second blade-root profile for operating within a second discharge range;
d. Installing the first screw conveyor portion into the conduit for operating the horizontal fluent material dispenser within the first discharge range; and
e. Installing the second screw conveyor portion into the conduit for operating the horizontal fluent material dispenser within the second discharge range.

12. A kit for adjusting the flow rate of a fluent material dispenser having a horizontal conduit, the kit comprising:
a. A first screw conveyor portion having:
i. A first total diameter; and
ii. A first blade-root profile optimized for a first discharge rate range;
b. A second screw conveyor portion having:
i. A second total diameter that is the same as the first total diameter;
ii. A second blade-root profile optimized for a second discharge rate range.

13. The kit of claim 12, wherein each screw conveyor portion is configured to be rotationally coupled to at least one of a hopper screw conveyor portion and a knife assembly.

14. The kit of claim 12, wherein each screw conveyor portion further comprises a knife assembly that rotates with the respective screw conveyor portion, the knife assembly comprising a plurality of vanes extending radially.

15. The kit of claim 14, wherein each of the vanes has an edge that is beveled.

16. The kit of claim 12, wherein the second blade-root profile has a larger diameter root than the first blade-root profile.

17. The kit of claim 12, wherein the second blade-root profile has a larger blade height than the first blade-root profile.

18. A horizontal fluent material dispenser comprising:
a. A first rotational power source;
b. A hopper comprising:
i. An open top portion;
ii. A lower portion;
iii. A mixing assembly disposed within the hopper, the mixing blade comprising:
1. An axle that extends horizontally through of the hopper, the axle being mechanically coupled to the first rotational power source to rotate the mixing assembly at a first mixing assembly speed;
2. A first blade mounted to the axle;
c. A horizontal conduit extending from the lower portion of the hopper, the horizontal conduit comprising:
i. A discharge aperture near the distal end;
d. A second rotational power source;
e. A hopper screw conveyor mechanically coupled to the second rotationally power source, the hopper screw conveyor disposed within the lower portion of the hopper;
f. A knife assembly rotationally coupled to the screw conveyor, the knife assembly disposed laterally adjacent to the discharge opening;
g. Wherein the screw conveyor is configured to rotate at a first conveyor speed independent of the first mixing assembly speed.

19. A method for increasing the discharge rate of a horizontal fluent material dispenser comprising:
a. Providing the apparatus of claim 18; and
b. Providing a first screw conveyor portion having:
i. A coupling assembly to transfer rotational power from the hopper screw conveyor to the first screw conveyor portion;
ii. A first total diameter equal to an inner surface diameter of the conduit; and
iii. A first blade-root profile for operating within a first discharge rate range;
c. Providing a second screw conveyor portion having:
i. A coupling assembly to transfer rotational power from the hopper screw conveyor to the first screw conveyor portion;
ii. A second total diameter equal to the inner surface diameter of the conduit; and
iii. A second blade-root profile for operating at a second discharge rate range;
d. Installing the first screw conveyor portion into the conduit for operating the horizontal fluent material dispenser within the first discharge rate range; and
e. Installing the second screw conveyor portion into the conduit for operating the horizontal fluent material dispenser within the second discharge rate range.
